(19) United States
(12) Patent Application Publication
(10) Pub. No.: US 2011/0085327 A1
(43) Pub. Date: Apr. 14, 2011

(54) Decorative light display with LEDs

(76) Inventor: Johnny Chen, Hsinchu City (TW)

(21) Appl. No.: 12/578,825

(22) Filed: Oct. 14, 2009

(51) Int. Cl. F21V 7/00

(52) U.S. Cl. 362/235; 362/249.06

(57) ABSTRACT

A decorative light display has a frame, a plurality of LED support members coupled to the frame and a plurality of LED electrical receptacles. Each receptacle is associated with an LED support member and positionable therein. A plurality of LEDs are provided, each coupled to an LED electrical receptacle. A plurality of reflective cap members are associated with an LED and having a geometry and surface that provides reflection and multi-directionality of light from each of an LED bulb to convert single point lighting from the LEDs to non-single point lighting. One or more electrical connectors is coupled to the LEDs.

### BACKGROUND

1. Field of Use

This invention relates generally to decorative holiday light displays, and more particularly to decorative holiday light displays that use LEDs.

2. Description of the Related Art

Around 1930, small filament lamps were put into practical use for display boards. With the improvements in the technology for the display control of such display devices, the small filament lamps have come to be used for a large-size monochrome animation screen for outdoor use. However, most of the present large-size outdoor screens have display elements of cold-cathode tubes.

Since the small filament lamps can emit light forward, sideward, and obliquely backward, that is, in all directions except backward from the base of the bulb where electrodes are mounted, they are used, for example, as the illuminations on Christmas trees, which can be seen from every direction.

Recently, in addition to the above described small filament lamps, Light emitting diodes (“LED”) lamps are used as light emitting elements with an LED element embedded in a transparent resin or glass bulb-shaped portion. An LED element can comprise an epoxy resin bulb-shaped portion formed with a flange incorporated into its base; two leads, one end of each is extended outside the bulb-shaped portion and the other end is embedded in the bulb-shaped portion; and an LED chip embedded in the bulb-shaped portion and connected to the ends of the two leads.

One LED element is provided for the LED chip. If the luminous energy of the LED lamp should be increased, the number of the LED chips embedded in the bulb-shaped portion is increased corresponding to the desired luminous energy. Increasing the luminous energy to a certain extent can also be realized by increasing the bias voltage applied to the LED element. Generally, the diameter of the bulb-shaped portion of the LED lamp is approximately 3 mm through 5 mm, and 10 mm at maximum.

Light emitted from the LED element is very directional. Therefore, the LED lamp is not suitable for applications where light should be emitted in all directions like illuminations on a Christmas tree. Normally, the LED lamp is used for a display screen of a device on which information can be read from the front, such as a time table board at a station, a flight information board at an airport, and the like.

LEDs consume considerably less power than incandescent light bulbs, making their use highly desirable. To increase the luminosity of LEDs, lenses are placed in front of them, which focuses the light into a beam that is essentially perpendicular to the LED junction base. Inevitably, light dispersion from the LED is decreased, which limits the use of LEDs to specialized illumination applications.

LEDs are readily available in the market place. Three of the “standard” LEDs are a basic LED, a bright LED and an ultra bright LED. The basic LED has an output level between 1.5 to 10 mcd and a viewing angle from 75 to 100 degrees. The bright LED has an output level between 10 to 50 mcd and a viewing angle from 50 to 75 degrees. The ultra bright LED has an output level between 50 to 2,000 mcd and a viewing angle from 18 to 60 degrees. All of these LEDs are useful for a focused light beam application that ranges from situations where there is no ambient light situations to those in daylight.

Recent developments in LED technology have resulted in the availability of “super high intensity” LEDs. Super high intensity LEDs are commonly used in cluster applications to replace standard “spot” lamp applications and traffic warning devices. The output level is between 6,000 to 20,000 mcd and the viewing angle is a very narrow 4 to 8 degrees. Yet, use of this powerful LED is still limited to focused light applications due to its narrow viewing angle design. A significant problem occurs when a LED is used and the viewer is outside the narrow range of its beam of light Intensity drops off precipitously.

Use of devices such as Fresnel lenses or reflectors can assist the human eye in detecting light emitted by an LED over wider viewing angles. However, use is still limited to relatively focused light applications designed for viewing directly in front of the LED.

Various attempts have been made to broaden the LED light beam. For example, a self-powered ornamental lighting device is described in U.S. Pat. No. 4,866,580 by Blackerby. This device includes a LED encased within a bulb. This bulb appears to have no particularly special refracting nor diffusing characteristics. In another embodiment, a metal foil reflector is used to reflect light emitted from the LED.

Similarly, German Patent Number 41 20 849 A1 by Sitz describes an ornamental lighting apparatus using an LED and a bulb enclosure having the characteristics of a candle flame. Like Blackerby above, this member also appears to have no particularly special refracting nor diffusing characteristics.

U.S. Pat. No. 4,965,488 by Hili describes a light-source multiplication device having a planer lens with multiple facets. An LED emits light toward the planer lens. Surrounding the LED is a reflector to reflect any laterally emitted light from the LED toward the planer lens. Light beams transmitted by the planer lens are parallel to one another.

An LED lamp, including a refractive lens element is described in U.S. Pat. No. 5,174,649 by Oilstone. The lamp includes one or more LEDs that illuminate the refractive lens element, which has hyperboloids and facets, to give the effect of its being fully illuminated. However, the lighting effect from the lens remains in a narrow viewing angle and in front of the LED. Once the viewer out of the viewing angle, the effect will not

U.S. Pat. No. 5,931,570 discloses an LED lamp etched on its surface into a frosted glass surface. It can also be processed with small particles of the same material as the LED lamp being applied onto the surface. Otherwise, the LED lamp can have an irregular cut-diamond-like surface. The surface of the LED lamp can also be covered with an optically-diffusing material. The base of the LED lamp can be designed to be removable from a socket. Thus, since the LED lamp is provided with a specific treatment on its surface, the light from the LED element is emitted in all directions, thereby realizing a small LED lamp for emitting light in all directions like a conventional small filament lamp. Furthermore, each LED lamp is non-fragile and durable, and has a low power consumption, thereby realizing an economical and easily-handled small LED lamp.

In practice, a large number of LED lamps are mounted to an LED matrix. An optically-diffusing plate, a legend plate, and a push button plate are sequentially mounted on the front of the LED matrix They are contained in a housing to be used as an LED unit, that is, for example, a push button.

However, since the above described filament lamps and cold-cathode tubes can be easily broken even when receiving only a small shock, because their bodies are made of thin glass bulb- or tube-shaped portions, they therefore require very careful handling and can give a lot of trouble to users. Furthermore, they are inconsistent in structure and luminous characteristics and have a relatively short operating life, thereby giving users the trouble of frequently replacing faulty bulb- and tube-shaped portions.

Furthermore, since such news boards require an enormous number of light emitting bulbs, the small filament lamps are not economical because each of the small filament lamps has a relatively high power consumption. On the other hand, the cold-cathode tube has the demerit in structure that it cannot form a small picture element of a screen like the small filament lamps.

The LED element also has the problem that it is limited in usage because it is directional in optical-emission as described above, although it is durable and consistent in emission characteristics. Furthermore, to obtain a light diffusing in all directions using the LED element, a great number of LED elements are required or an optically-diffusing board must be provided.

Additionally, a time table board at a station and a flight information board at an airport are also required to be seen from all directions, in order to allow the users to recognize the existence of the time table board or the flight information board from the side of the boards, even if they cannot correctly read the displayed characters, etc.

U.S. Pat. No. 5,931,570 discloses an LED lamp etched on its surface into a frosted glass surface. It can also be processed with small particles of the same material as the LED lamp being applied onto the surface. Otherwise, the LED lamp can have an irregular cut-diamond-like surface. The surface of the LED lamp can also be covered with an optically-diffusing material. The base of the LED lamp can be designed to be removable from a socket. Thus, since the LED lamp is provided with a specific treatment on its surface, the light from the LED element is emitted in all directions, thereby realizing a small LED lamp for emitting light in all directions like a conventional small filament lamp.

Furthermore, each LED lamp is non-fragile and durable, and has a low power consumption, thereby realizing an economical and easily-handled small LED lamp.

### SUMMARY

An object of the present invention is to provide improved decorative holiday light displays.

Another object of the present invention is to provide decorative holiday light displays that use LEDs.

A further object of the present invention is to provide decorative holiday light displays that use LEDs with reflectors to provide greater dispersion of light from the LED.

These and other objects of the present invention are achieved in decorative light display with a frame, a plurality of LED support members coupled to the frame and a plurality of LED electrical receptacles. Each receptacle is associated with an LED support member and positionable therein. A plurality of LEDs are provided, each coupled to an LED electrical receptacle. A plurality of reflective cap members are associated with an LED and having a geometry and surface that provides reflection and multi-directionality of light from each of an LED bulb to convert single point lighting from the LEDs to non-single point lighting. One or more electrical connectors is coupled to the LEDs.

### BRIEF DESCRIPTION OF THE DRAWINGS

FIG. 1(a) is a perspective view of one embodiment illustrating a decorative light display of the present invention.

FIG. 1(b) is a exploded view of an embodiment illustrating the LED, cap and receptacle of FIG. 1(a)

FIG. 2(a) is a cross sectional view of a cap member 20 in one embodiment of the present invention.

FIG. 2(b) illustrates one embodiment of an exterior surface of a cap member of the present invention and an interior surface.

FIG. 3 illustrates that each LED produces light at an angle of divergence of x and each reflective cap member increase the angle of divergence to y,

FIG. 4 is an electrical schematic of the circuitry used in the present lighted display device.

FIG. 5 is a graph showing the relative intensities of the various colors emitted by the LEDs of the present device, when electrical power thereto is varied according to a predetermined program.

FIG. 6 is a flow chart showing the sequential operation of the present device according to the switch actuation and programming thereof.

### DETAILED DESCRIPTION

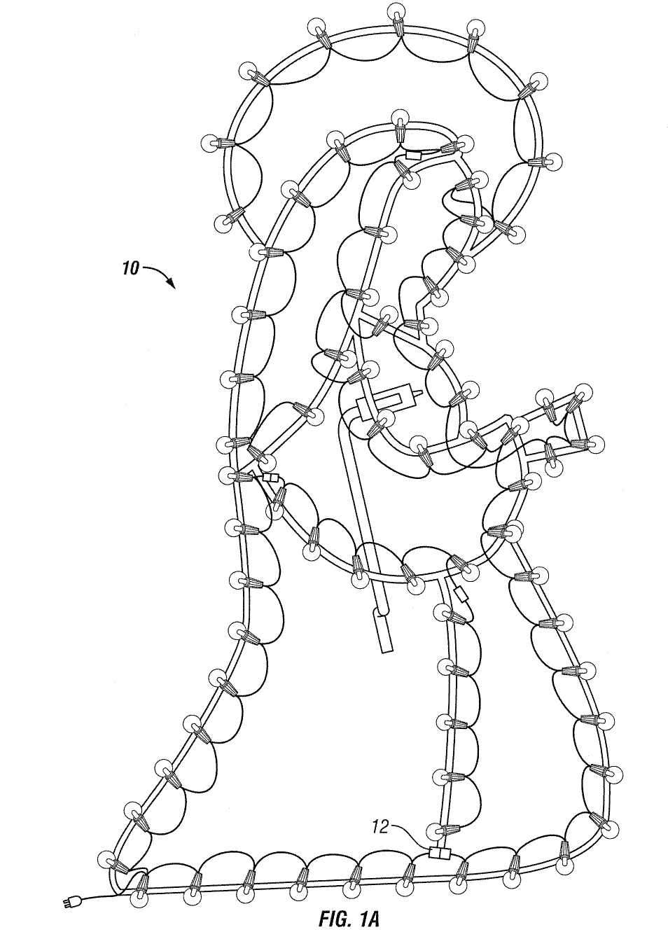

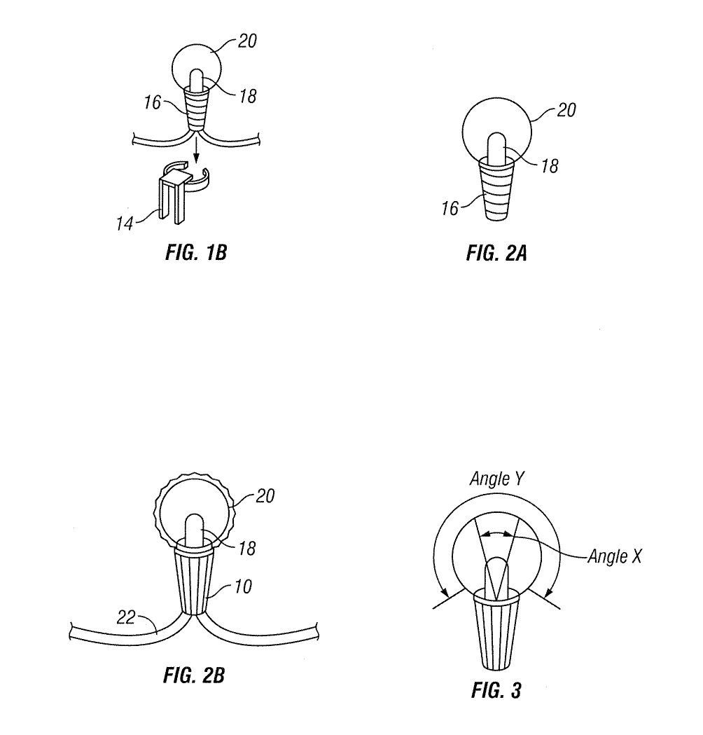

As illustrated in FIGS. 1(a) and 1(b), one embodiment of the present invention is a decorative light display 10 that includes a frame 12 and a plurality of LED support members 14 coupled to the frame 10. LED electrical receptacles 16 are provided. A plurality of LEDs 18 are provided, with each LED 18 being electrically coupled to an LED receptacle 16. In various embodiments, the size of the LEDs 18 1-2 mm, 1-3 mm, 3-5 mm, no greater than 10 mm, and the like.

Reflective cap members 20 are associated with the LEDs 16. Alternatively, the cap members 20 need not be dispersive and a dispersive member can be positioned external to the LED and in an interior of the cap member 20.

FIG. 2(a) illustrates a cross sectional view of the cap member 20 and its associated LED 18. The cap members 20 have a geometry and surface that provides reflection and multi-directionality of light from each of LED 18, converting single point lighting from the LEDs 18 to non-single point lighting. The cap members 20 can be frosted and have a textured surface that provides multi-directionally of light from the LED 18. One or more electrical connectors 22 coupled to the LEDs. FIG. 2(b) illustrates one embodiment of an exterior surface of a cap member of the present invention and an interior surface.

In one embodiment, the LED support members 14 have a first section that attaches to the frame 12, and a lateral portion that is laterally positioned relative to the frame. The lateral portion receives the electrical receptacle and in this manner places the LED 18 at a lateral position relative to the frame.

In one embodiment, each electrical receptacle can be removably locked into an LED support member 14. In one embodiment, the LED support members 14 are positioned in linear arrays. In one embodiment, he plurality of LEDs 18 is a string of LEDs 18.

Referring now to FIG. 3, each of LED 18 produces light at an angle of divergence of x. Each reflective cap member 20 increase the angle of divergence to y, wherein y is at least five times the size of x. The purpose of the divergence is to increase the spread of the LED 18 illumination to a much larger area. In another embodiment, y is at least ten times the size of x. In one embodiment, y is sufficiently large to create a substantially spherical or semi-spherical dispersion of x. In another embodiment, y is sufficiently large to create a substantially spherical dispersion of x. By way of illustration, and without limitation, y can be sufficiently large to create a substantially spherical dispersion of x of at least, 220 degrees, 280 degrees, 300 degrees and the like. In one embodiment, LEDs 18 are positioned to emit light in a single direction relative to the frame.

The shape of the cap member 20 is a significant factor in defining x, as is the characteristic of the surface of the cap member 20.

In one embodiment, the LED support members 14 are all positioned on a same side of the frame.

In one embodiment, each LED 18 extends in a same direction away from the frame. In another embodiment, each LED 18 is perpendicular to the frame. In one embodiment, each LED 18 points in a direction away from the frame and all of the LEDs 18 are positioned on a same side of the frame.

In one embodiment, at least a portion of the LEDs 18 are arranged as a linear silhouette. In another embodiment, all of the LEDs 18 are arranged as linear silhouettes. At least a portion of the LEDs 18 can be arranged in linear arrangements.

In one embodiment, each cap member 20 has an interior smooth surface and an exterior textured or rough surface. The texture can be in the form of raised protrusions, dimples and valleys, and the like. The exterior surface serves to disperse the light from the LED 18. The interior surface of the cap member 20 can also be dispersive, and the exterior surface smooth. All or a portion of the cap members 20 can be colored, and have different colors.

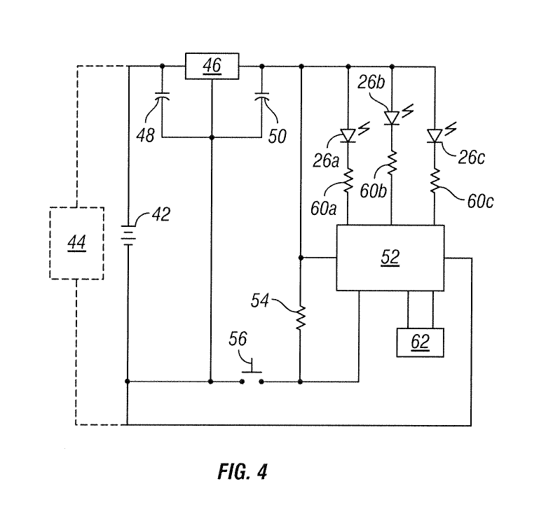

The LEDs are shown schematically in the electrical circuit of FIG. 4, and as a non-limiting example, are designated as LEDs 18a, 18b, 18c etc. FIG. 4 discloses one embodiment of electrical circuitry for the operation of the present lighted display device in its various embodiments. The present circuitry may be powered by an electrical battery 42 (e.g., nine volt DC rectangular “radio battery,” etc.) or by a suitable power supply 44 (e.g., 115 volt AC “household current”), indicated as an alternative by the block in broken lines in FIG. 4. Electrical power is provided to an appropriate power supply 46, for converting the electrical energy to the proper voltage and frequency as required. A National Semiconductor 78L05 has been found to be suitable; other suitable types and configurations may be used as desired.

First and second capacitors 48 and 50 are placed in parallel respectively with the input and output sides of the power supply 46, with the first capacitor 48 reducing spurious high frequency signals or “noise” and the second capacitor 50 smoothing the output signal from the power supply 46. Power from the power supply 46 is provided to a suitable micro control unit 52; a Phillips 51LPC has been found to be suitable for controlling the present electrical circuit. Other equivalent devices may be substituted therefore, as desired. Power is provided directly to one input, and through a resistor 54 to a second input. The second input is selectively grounded through a normally open switch 56, which may be installed on the circuit board and accessed through an appropriate passage 58. The control unit 52 changes its operating condition each time the circuit is momentarily grounded by switch 56, to select the specific program to operate the three LEDs 18a through 18c.

The LEDs 18 receive power directly from the power supply 46, and are grounded through the micro control unit 52 and suitable resistors, respectively 60a through 60c, in series with each of the LEDs 18a through 18c. The micro control unit 52 selectively controls the current flow across each of the LEDs 18, either collectively or separately as desired, by controlling their ground state within the micro control unit 52 according to its programming, as described further below. A 20 mHz crystal timer oscillator 62 (or other suitable equivalent) is provided for controlling the operational time intervals of the LEDs.

The programming of the microcontroller 52 provides yet another benefit, by permitting the maximum intensity of any of the LEDs to be adjusted. Generally, blue color LEDs produce a lower perceived brightness than other colors of LEDs, even with the same amount of power being applied thereto. (Advances may permit more efficient blue LEDs to be used with the present invention.) Thus, in order to achieve the same perceived brightness from each of the LEDs, the red and yellow LEDs may be limited by providing higher resistances in their ground states, thus allowing less electrical power to flow therethrough. As the intensities are a perceived condition, the ground states (and intensities) may be adjusted as desired.

As noted above, the present ornamental display 10 with its programmable controller 52 permits virtually any color combination to be produced by the three differently colored LEDs 18a through 18c, and provides for the automated sequential or simultaneous activation of any or all of the LEDs 18.

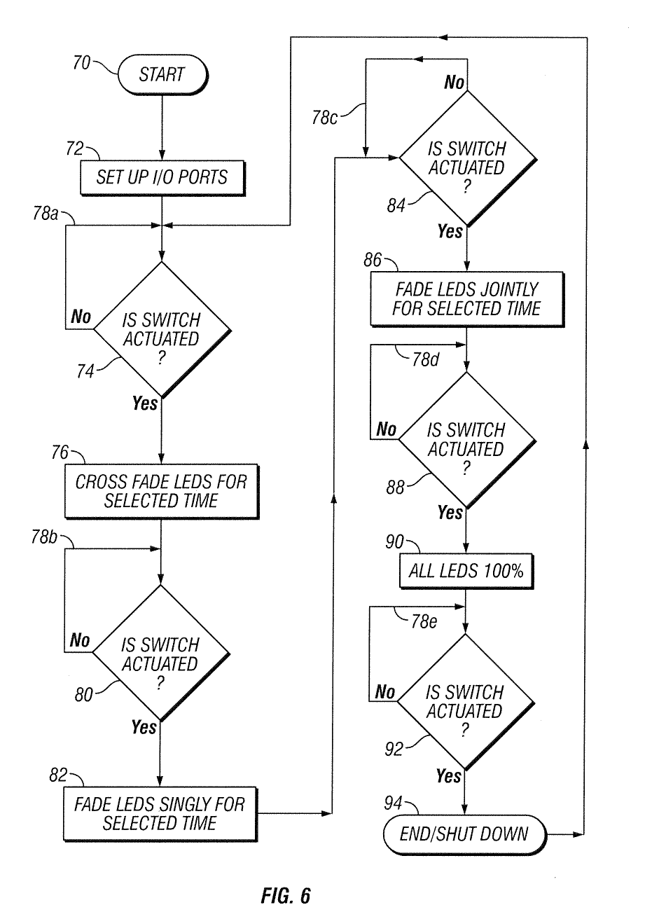

FIG. 6 provides a flow chart showing the general steps in the programming which might be used with the present invention. Basically, the micro control unit 52 is programmed to “count” sequentially the number of times the switch 56 has been momentarily closed, with each closure resulting in a different sequence of actuation for the three LEDs 18.

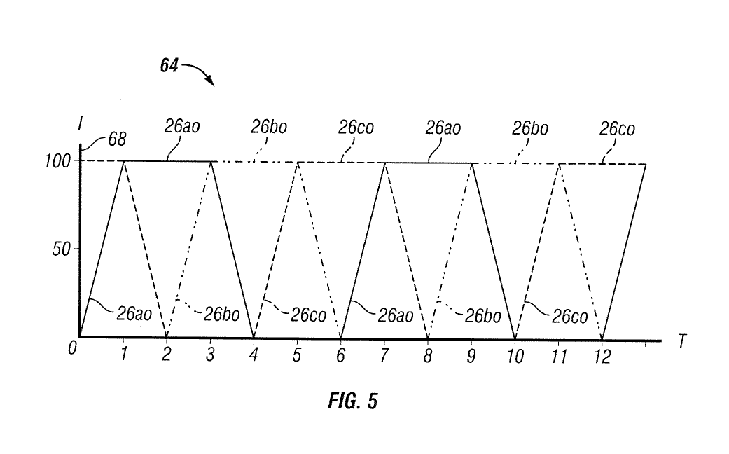

Beginning with the “Start” position 70 in the flow chart of FIG. 5, the controller 52 initializes the operation according to the “Setup” position 72 and signals the three LEDs 18 to produce no light, by providing an essentially infinite resistance to their ground states across the resistors 60a through 60c of the electrical schematic of FIG. 4. Thus, the system is essentially off at this point (with the exception of the internal operation of the micro control unit 52). The system next checks for switch actuation, as indicated by the next step 74 of FIG. 6. If the switch 56 is closed once, the micro control unit is programmed to “cross fade” the three LEDs 18a through 18c as indicated in the fourth step 76 of FIG. 6, i.e., raise and lower their intensities sequentially, as in the operation illustrated in the graph 64 of FIG. 5 and described above. This operation may be performed for a predetermined period of time, or may continue until the switch 56 is again momentarily closed.

In the event that no switch actuation has been detected by the micro control unit 52, the program is set up to “loop” back to continue to check for switch actuation, as indicated by the non-activation switch loop 78a of FIG. 6. Until the control unit 52 detects a subsequent switch actuation, it will continue to operate the most recently selected program for a predetermined period of time, or until another switch actuation is detected to signal it to switch to the next program in the sequence.

If a person wishes to activate some other preprogrammed operation of the present display device 10, other than the “cross fade” operation of the block 76 of FIG. 6, the switch 56 is momentarily closed for a second time. The micro control unit 52 detects this second switch actuation, as indicated by step 80, and is programmed to fade each of the LEDs 18a through 18c singly for some predetermined period of time (or until another operation is selected), as indicated by the second operation 82 of FIG. 6. The controller 52 continues to check for further switch operation, and if no further switch actuation is detected, loops back as indicated by the second loop 78b to continue the last selected operation.

This process continues, with a third switch actuation (step 84) causing the microcontroller 52 to switch to the next program in sequence, e.g., the “Fade LEDs jointly for selected time” step 86 of FIG. 6. The program then continues to check for further switch actuation, looping back via the loop 78d if no further switch actuation is detected.

A fourth switch actuation, indicated by the fourth actuation step 88 of FIG. 6, results in the micro control unit 52 switching to the next program in the system, e.g., turning all of the three LEDs 18a through 18c to one hundred percent of perceived intensity, as described generally in the fourth operational step 90 of FIG. 6. (Again, the actual ground resistance provided for each of the LEDs may vary in order to provide the desired equal perceived intensity or brightness to the human eye.) The microcontroller 52 continues to check for further switch operation by means of the loop 78e, and continues to run the program of the fourth step 90 until further switch actuation is detected.

If yet another switch actuation is detected, as indicated by the fifth switch actuation step 92 of FIG. 6, the control unit 52 is programmed to increase the resistance to each of the LEDs 18a through 18c to create essentially “open circuits,” thus effectively shutting the system down, as indicated by the final step 94 of FIG. 6. Reactivation of the system is easily accomplished by actuating the switch 52 one more time, whereupon the system reinitiates with the “cross fade” operation 76 once again. It will be seen that the programming generally described herein may be varied and modified as desired, in order to provide still other effects than those described herein and shown in the flow chart of FIG. 6 of the present disclosure. For example, one of the LEDs could remain off, while the other two are cycled to produce a limited color array. Also, the exemplary program steps of FIG. 6 may be interchanged or modified as desired.

It is to be understood that the present invention is not limited to the embodiments described above, but encompasses any and all embodiments within the scope of the following claims.

What is claimed is:

1. A decorative light display comprising:
a frame,
a plurality of LED support members coupled to the frame;
a plurality of LED electrical receptacles, each of a receptacle being associated with an LED support member and positionable therein;
a plurality of LEDs, each of an LED coupled to an LED electrical receptacle
a plurality of reflective cap members, each of a reflective member being associated with an LED and having a geometry and surface that provides reflection and multi-directionality of light from each of an LED bulb to convert single point lighting from the LEDs to non-single point lighting;
one or more electrical connectors coupled to the LEDs.

2. The display of claim 1, wherein each of an LED produces light at an angle of divergence of x and each of a reflective cap member increase the angle of divergence to y, wherein y is at least five times the size of x.

3. The display of claim 1, wherein each of an LED produces light at an angle of divergence of x and each of a reflective cap member increase the angle of divergence to y, wherein y is at least ten times the size of x.

4. The display of claim 2, wherein y is sufficiently large to create a substantially spherical or semi-spherical dispersion of x.

5. The display of claim 2, wherein y is sufficiently large to create a substantially spherical dispersion of x.

6. The display of claim 2, wherein y is sufficiently large to create a substantially spherical dispersion of x of at least 220 degrees.

7. The display of claim 2, wherein y is sufficiently large to create a substantially spherical dispersion of x of at least 280 degrees.

8. The display of claim 2, wherein y is sufficiently large to create a substantially spherical dispersion of x of at least 300 degrees.

9. The display of claim 2, wherein a shape of a cap member defines x.

10. The display of claim 1, wherein each of an LED extends in a same direction away from the frame.

11. The display of claim 1, wherein each of an LED is perpendicular to the frame.

12. The display of claim 1, wherein each of an LED points in a direction away from the frame and all of the LEDs are position on a same side of the frame.

13. The display of claim 1, wherein at least a portion of the LEDs are arranged as a linear silhouette.

14. The display of claim 1, wherein at least a portion of the LEDs are arranged in linear arrangements.

15. The display of claim 1, wherein each of a cap has an interior smooth surface and an exterior textured surface.

16. The display of claim 15, wherein the exterior textured surface of each of a cap creates a dispersive transmission of light.

17. The display of claim 1, wherein each of an LED is locked into an LED support member.

18. The display of claim 1, wherein each of an LED support member has a portion that attaches to the frame, and a lateral portion that extends laterally relative to the frame.

19. The display of claim 18, wherein each of a lateral portion is configured to receive an LED receptacle.

20. The display of claim 1, wherein each of an LED is removably locked into an LED support member.

21. The display of claim 1, wherein at least a portion of caps are colored.

22. The display of claim 1, wherein at least a portion of the caps are different colors.

23. The display of claim 1, wherein the LEDs are positioned to emit light in a direction away from the frame.

24. The display of claim 1, wherein the LED support members are all positioned on a same side of the frame.

25. The display of claim 1, wherein the LED support members are positioned in linear arrays.

26. The display of claim 1, wherein the reflectors are positioned at exterior surfaces of the LEDs.

27. The display of claim 1, wherein reflectors are positioned relative to the LEDs to disperse the point source light from the LEDs.

28. The display of claim 1, wherein the plurality of LEDs is a string of LEDs.

29. The display of claim 1, wherein the caps are frosted.
